(19) United States
(12) Patent Application Publication
(10) Pub. No.: US 2004/0252232 A1
(43) Pub. Date: Dec. 16, 2004

(54) Edge oriented interpolation of video data

(76) Inventors: Rogier Lodder, Eindhoven (NL); Gerard De Haan, Eindhoven (NL)

Correspondence Address: Philips Electronics North America Corporation, Corporate Patent Counsel, PO Box 3001, Briarcliff Manor, NY, 10510, US

(21) Appl. No.: 10/493,804

(22) PCT Filed: Oct. 18, 2002
(86) PCT No.: PCT/IB02/04342

(30) Foreign Application Priority Data
Nov. 1, 2001 (EP) 01204200.8

(51) Int. Cl. H04N 9/74; H04N 7/01

(52) U.S. Cl. 348/448; 348/625; 348/581

(57) ABSTRACT

The invention relates to a method for error reduction during interpolation of pixels in a video image along edges. By combining the output of two interpolation methods (4,6) and by calculating a mix factor (k) using only the output of one interpolation method, the interpolation results may be improved. When applying the estimation error of edge-dependent interpolation in direction of a pixel obtained with a second interpolation method, the output is improved.

The invention relates to a method and a device for edge oriented spatial interpolation of video images.

By comparing spatial edge oriented interpolation with standard interpolation results, and by weighting these results using the reliability of edge oriented interpolation, the output of an interpolation is enhanced. This is possible in case of spatial scaling, de-interlacing to generate progressive video images, and in post processing of already de-interlaced images.

Spatial scaling is necessary whenever the number of pixels on a video line, or the number of video lines in an input video signal differs from the number required for display. This is in case an interlaced video signal has to be de-interlaced for providing a progressive video signal or when an aspect ratio has to be adapted as the display device requests a different ratio as the original signal can provide. High quality spatial scaling is achieved by up-scaling, using an interpolating low-pass filter. In this filter an input signal is at first sampled with a sampling frequency twice the desired bandwidth. The samples are interpolated and then decimated by zero-stuffing methods. The bandwidth of the input signal is not degraded, but also no additional spectral components can be used to improve the picture.

U.S. Pat. No. 5,661,525 describes a method and an apparatus for converting, or de-interlacing a sequence of video frames which are represented using the interlaced scan format to a progressively scanned format. According to this disclosure, a plurality of interpolations are carried out on input video images. Pixels which need accurate interpolation are interpolated subsequent to pixels which do not need accurate interpolation. Interpolations are performed in this sequence to minimize the error of estimated pixel values. Each interpolation is weighted according to its estimated reliability. By weighting the interpolated values, the pixel values of a de-interlaced frame contain a minimized error.

The drawback of this method is that the computation effort is very high. By interpolating pixels with different interpolation methods, a large amount of data is generated. When each of these pixel values is weighted, computation overhead increases, which makes an apparatus for de-interlacing video images quite expensive. Another drawback of this prior art system is that for some interpolation methods it is not evident how to estimate the reliability.

It is an object of the invention to provide a lean and inexpensive method and apparatus to interpolate pixel values between existing pixels of a video image that does not require estimation/calculation of the reliability of all interpolation methods. The invention is defined by the independent claims. The dependent claims define advantageous embodiments.

Advantageously, a fast interpolation may be provided, where computation time is reduced.

In case of edge oriented de-interlacing or spatial scaling, severe artefacts may occur in case an edge orientation has been estimated erroneously. As such edge orientation detection errors are unavoidable with currently known methods, particularly in picture parts with little detail, error correction should be carried out. By post processing an edge oriented interpolated image by mixing different interpolation methods according to the invention, good results are achieved. The more reliable an edge-dependent interpolation is, the less should the output of a different interpolator be used, and vice versa. By mixing interpolation results, the output is at least as good as it was previous to post-processing.

One example of an edge-dependent interpolation that is suitable for use in the present invention has been described in the article “Progressive scan conversion using edge information”, by T. Doyle and M. Looymans, in Signal Processing of HDTV, II, L. Chiariglione (ed), 1990, pp. 711-721.

An edge-dependent interpolation is reliable, in case long, sharp edges have been detected. In this case this output should be weighted higher then in case of low detail and no edges in the image.

Second pixels are preferably interpolated according to claim 2, as these interpolation method guarantee a robust interpolation with good results. Blurring and other drawbacks of these interpolation methods are reduced.

A method according to claim 3 is further preferred. The result of an edge-dependent interpolation may be improved by a robust interpolation method that does not suffer from robustness problems. The drawbacks of the two interpolation methods level each other to some extent, so that the over all result can be improved. When the mix parameter is set such that the absolute difference between the over all output and the edge-dependent output is a constant fraction times the difference between existing pixels along the edge, the output is robust.

A mix factor according to claim 4 or 5 is further proposed. By adjusting the mix factor, the output results can be adjusted. The constant may rely on the spatial position of the interpolated pixel between the existing pixels, which are the base for the interpolation. The essence is that the absolute difference between the output and the edge-dependent interpolated pixels equals a constant number of times, preferably two times if the interpolation output is halfway between the interpolation inputs, the absolute difference of the original pixels for edge-dependent interpolation.

According to claim 6 the mix factor depends on two values, first the angular difference, which is a measure for how accurately an edge has been found, and second the surrounding, in particular the vertical or horizontal, difference, which is a measure for how relevant the angular interpolation is at this point. A constant w may be used to put more emphasis on either the angular or the surrounding average, according to the needs of the particular application or to personal preferences. It is preferred that the mix factor is clipped to 1.

According to claim 7, the mix factor is used to mix the angular average and the original output from a second interpolator, i.e. a motion compensated de-interlacer. Only one de-interlacing method provides an error measure, and the mixing is done only according to that measure.

A further aspect of the invention is the use of a described method or a described device, in scan rate converters, in video compressors or in de-interlacing devices, display systems or television.

These and other aspects of the invention will become apparent from and be elucidated with reference to the embodiments described hereinafter.

In the drawings:

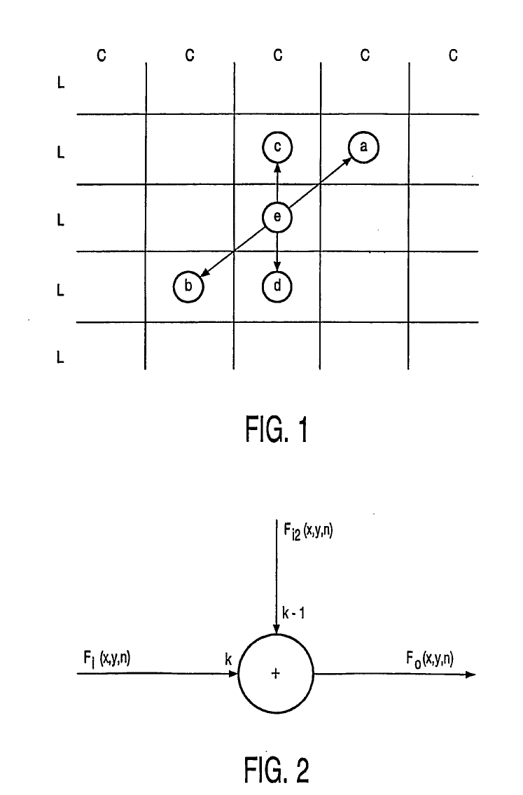

FIG. 1 shows a display matrix;

FIG. 2 shows a calculation of output pixels; and

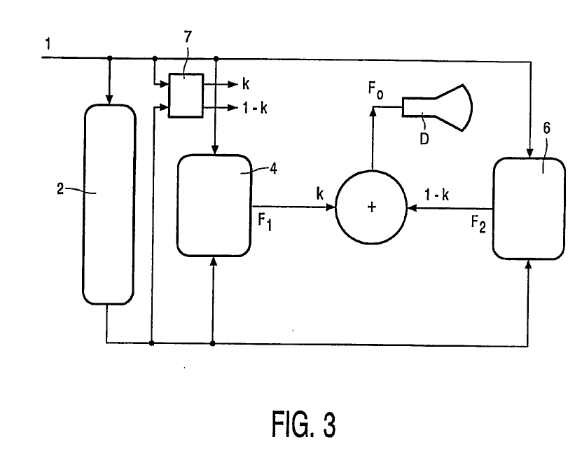

FIG. 3 shows a block diagram of an implementation.

FIG. 1 depicts a display matrix with vertical lines L and horizontal columns C. Each intersection of lines L and columns C contains a pixel, which value is an eight bit color representation of the original point in the image to be displayed. Depicted are pixels a, b, c, d, and e. Pixels a, b are along a detected edge of the image. Pixels c, d are vertically arranged around the pixel e, which is to be interpolated. As in interlaced video signals every second line L is not transmitted and the missing information is generated by interpolation, it is crucial that interpolation values come close to the original values. By interpolating along pixels a, b along an edge and pixels c, d vertically offset from the pixel e to be interpolated, the correctness of the calculated value is improved.

In FIG. 2, the calculation of an output value F₀(x,y,n) by adding the output Fᵢ(x,y,n) of an edge-dependent interpolation and the output Fᵢ₂(x,y,n) of a motion compensated interpolation with a mix factor k is shown. The output of an edge-dependent interpolation is Fᵢ(x,y,n), depending on the original pixel values a, b. When the interpolation angle is detected, it is possible to predict a from b and vice versa. If the interpolation pixel e has a position exactly in between a, and b the prediction error can be expected to be twice as small as the prediction error of b when predicted using a. That means that the correct value of e can deviate from one calculated with the interpolation angle, but this deviation is expected to be two times smaller than the absolute difference between the values of a, and b.

When improving the robustness of the edge-dependent interpolation, a second interpolation method is needed, which does not suffer from robustness problems. That may be linear interpolation along c, and d. By mixing the output of the second interpolation Fᵢ₂(x,y,n) with the output of the edge-dependent interpolation Fᵢ(x,y,n), using a mixer as shown in FIG. 2, where k is set such that the absolute difference between F₀(x,y,n) and Fᵢ(x,y,n) equals half the absolute difference of pixel values b, and a, interpolation results may be improved.

Formally the mix factor k is calculated by.

|a−b|=2*|F₀(x,y,n)−Fᵢ(x,y,n)|

The output is further defined by:

F₀(x,y,n)=kFᵢ(x,y,n)+(1−k)Fᵢ₂(x,y,n)

This leads to:

$$( 1 - k ) = \frac{\vert a - b \vert}{2 \vert {F}_{i2} ( x , y , n ) - {F}_{i} ( x , y , n ) \vert + δ}$$

The value δ prevents from a division by zero. It is preferred that k is clipped to 1. The factor 2 in the denominator results from the distance relation between a, and b.

FIG. 3 depicts a block diagram of an implementation of an improved interpolator. An input signal 1 is fed to a line memory 2, where the values of pixels of lines are stored to allow interpolation in between lines. The input signal 1 is further fed to edge-dependent interpolation 4 and to line interpolation 6. The stored pixel values of previous lines are fed from line memory 2 to edge-dependent interpolation 4 and to line interpolation 6. The mix factors k and 1-k are calculated by mix factor calculation device 7. The output of edge-dependent interpolation 4 Fᵢ(x,y,n) is weighted with mix factor k. The output of line interpolation 6 is weighted with (1-k). These weighted output values are added and result in an output value F₀(x,y,n) that is displayed by display device D.

By weighting the output values according to the invention, it is possible to provide interpolation results that depend on current picture characteristics. In case edge-dependent interpolation is superior to other interpolation methods, its results are emphasized, and vice versa.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

Reference signs:

| | |
|---|---|
| a, b, c, d | original pixels |
| e | interpolated pixel |
| k | mix factor |
| C | columns |
| L | lines |
| Fᵢ(x, y, n) | output of edge-dependent interpolation |
| Fᵢ₂(x, y, n) | output of line averaging interpolation |
| F₀(x, y, n) | interpolation output |
| 1 | input signal |
| 2 | line memory |
| 4 | edge-dependent interpolation |
| 6 | line averaging interpolation |
| 7 | mix factor calculation device |
| D | display device |

1. A method for error reduction of edge oriented spatial interpolation of video images, the method comprising the steps of:
calculating first interpolated pixels (F₁) between existing pixels (a, b) along spatial edges in said video image,
interpolating second interpolated pixels (F₂) between existing pixels,
calculating a mix factor (k) reflecting the reliability of said first interpolated pixels (F₁), and
calculating output interpolated pixels (F₀) by mixing said first interpolates pixels (F₁) with said second interpolated pixels (F₂) using said mix factor (k).

2. A method according to claim 1, characterized by calculating said second pixels (F₂) based on motion compensated or motion adaptive or linear interpolation.

3. A method according to claim 1, characterized by measuring a first absolute difference between pixel values of existing pixels along said spatial edge, measuring a second absolute difference between pixel values of said output interpolated pixels and said first interpolated pixels, calculating said mix factor such that said second absolute difference is a constant times said first absolute difference.

4. A method according to claim 3, characterized in that said constant is 2, in case said interpolated output pixel is interpolated spatially halfway between said existing pixels along said edge.

5. A method according to claim 3, characterized in that said constant depends on the spatial position relative to said existing pixels along said edge.

6. A method according to claim 1, characterized by measuring a first absolute difference between pixel values of existing pixels along said spatial edge (|a-b|), measuring a second absolute difference between values of pixels spatially surrounding said output pixel (|c-d|), and calculating said mix factor such that it is |a-b|/(w*|c-d|), where w is a constant.

7. A method according to claim 1, characterized by calculating said output pixel values such that Fₒ=k*F₁+(1−k)*\overline{ab}.

8. A device for interpolating pixels between existing pixels in video images, the device comprising:
first interpolation means (4) for interpolating first pixels (F1) between existing pixels along detected edges in said video image,
second interpolation means (6) for interpolating second pixels (F2) between existing pixels,
calculation means (7) for calculating a mix factor (k) reflecting the reliability of said first pixels (F1), and
mixing means (+) for mixing said first interpolated pixels (F1) with said second pixels (F2) in accordance with said mix factor (k), to obtain an output signal (Fo).

9. Display apparatus, comprising:
an interpolating device according to claim 8; and
a display device (D) for displaying the output signal (Fo).
